(19) United States
(12) Patent Application Publication
(10) Pub. No.: US 2011/0128603 A1
(43) Pub. Date: Jun. 2, 2011

(54) FOCAL PLANE SHUTTER AND OPTICAL DEVICE

(75) Inventors: Yoichi NAKANO, Chiba (JP); Makoto Mikami, Chiba (JP)

(73) Assignee: SEIKO PRECISION INC., Narashino-shi (JP)

(21) Appl. No.: 12/942,479

(22) Filed: Nov. 9, 2010

(30) Foreign Application Priority Data
Nov. 27, 2009 (JP) 2009-269526

(51) Int. Cl. G02B 26/02

(52) U.S. Cl. 359/230

(57) ABSTRACT

A focal plane shutter includes: a board including an opening; a blade closing and opening the opening; a driving lever holding a movable iron piece, swingably supported, and driving the blade; a self-holding solenoid being able to adsorb the movable iron piece in a non-energized state, and an adsorptive force in an energized state being smaller than an adsorptive force in the non-energized state; and a biasing member biasing the driving lever to move away from the self-holding solenoid. The driving lever includes an engagement portion engaging the movable iron piece and made of a non-magnetic material.

### CROSS-REFERENCE TO RELATED APPLICATION

This application is a continuation of and claims priority to Japanese Patent Application No. 2009-269526 filed on Nov. 27, 2009, subject matter of these patent documents is incorporated by reference herein in its entirety.

### BACKGROUND

(i) Technical Field

The present invention relates to focal plane shutters and optical devices.

(ii) Related Art

An aperture device with a self-holding solenoid is disclosed in Japanese Published Unexamined Application No. 2004-363462. The self-holding solenoid includes: a yoke; a coil exciting the yoke; a permanent magnet secured to the yoke; a movable iron piece which is adsorbed to the yoke by a magnetic force of the permanent magnet when the coil is not energized and which is moved away from the yoke by energizing the coil such that the magnetic force effecting the yoke is canceled.

For example, if the movable iron piece is provided in a driving lever of a focal plane shutter, it is conceivable that the movable iron piece engages an engagement portion of the driving lever to be held. In a case where the engagement portion is made of a magnetic material, it is possible for the engagement portion to become magnetized after a long period is elapsed with the movable iron piece adsorbed to the yoke. When the engagement portion is magnetized, the adsorption force effecting the movable iron piece is increased, as compared with a case where the engagement portion is not magnetized.

On the other hand, the driving lever is biased with a constant force by a biasing member to move away from the yoke. Therefore, if there are variations in the adsorption force effecting the movable iron piece, there are also variations in the period from the time the coil starts to be energized to the time the magnetic force effecting the yoke is canceled. That is, the time the movable iron piece moves away from the yoke is different, depending on a case where the engagement portion is magnetized or is not magnetized. For this reason, there are variations in the time the driving lever moves away from the self-holding solenoid. Thus, the variations in the shutter operation might be increased, this causes the variations in the shutter speed.

### SUMMARY

It is therefore an object to provide a focal plane shutter and an optical device that suppress the variations in the shutter operation.

According to an aspect of the present invention, there is provided a focal plane shutter including: a board including an opening; a blade closing and opening the opening; a driving lever holding a movable iron piece, swingably supported, and driving the blade; a self-holding solenoid being able to adsorb the movable iron piece in a non-energized state, and an adsorptive force in an energized state being smaller than an adsorptive force in the non-energized state; and a biasing member biasing the driving lever to move away from the self-holding solenoid, wherein the driving lever includes an engagement portion engaging the movable iron piece and made of a non-magnetic material.

### BRIEF DESCRIPTION OF THE DRAWINGS

FIG. 1 is a front view of a focal plane shutter according to the present embodiment;

FIG. 2 is a front view of a part of the focal plane shutter;

FIG. 3 is a front view of a part of the focal plane shutter;

FIG. 4 is an explanatory view of the operation of the focal plane shutter;

FIG. 5 is an explanatory view of the operation of the focal plane shutter;

FIG. 6 is an explanatory view of the operation of the focal plane shutter;

FIG. 7 is an explanatory view of the operation of the focal plane shutter;

FIG. 8 is an explanatory view of the operation of the focal plane shutter;

FIG. 9 is a top view of a self-holding solenoid;

FIG. 10 is a side view of the self-holding solenoid; and

FIG. 11A is a graph showing the relationships between an adsorption force effecting on a movable iron piece and a biasing force effecting on a trailing blade-driving lever, and FIG. 11B is a graph showing the energization state of the self-holding solenoid.

### DETAILED DESCRIPTION

In the following, the present embodiment according to the present invention will be described with reference to the drawings.

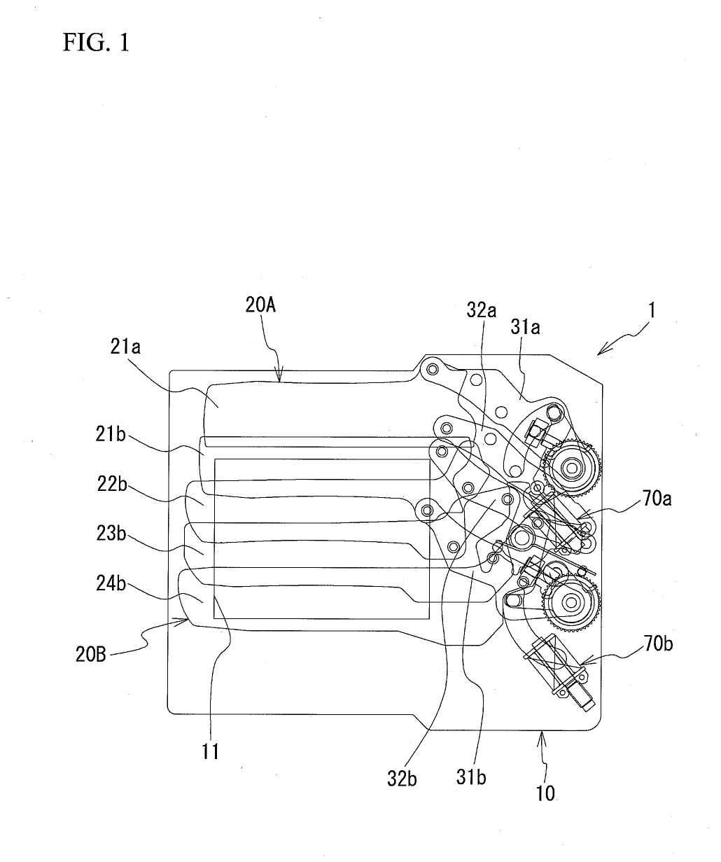

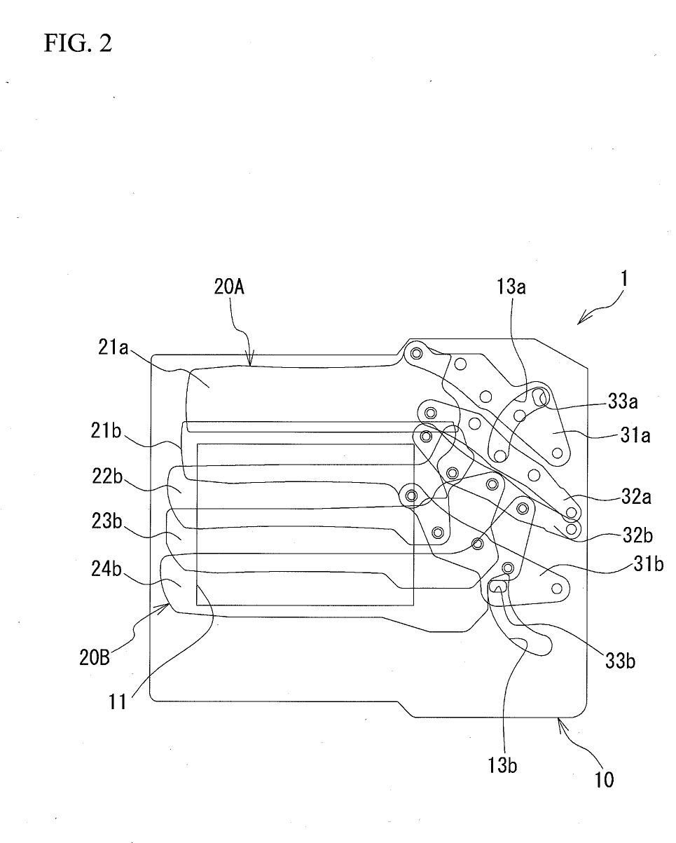

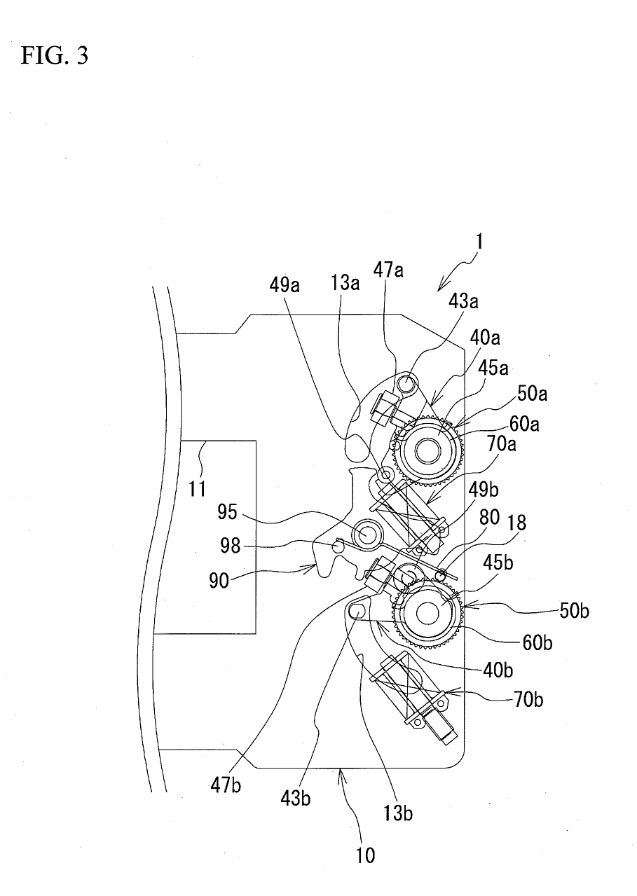

FIG. 1 is a front view of a focal plane shutter according to the present embodiment. FIGS. 2 and 3 are front views of a part of the focal plane shutter. Additionally, reference numerals are given to some of the parts in FIGS. 1 to 3.

As illustrated in FIG. 1, a focal plane shutter 1 includes a board 10, blades 21a, 21b to 24b, arms 31a, 32a, 31b, and 32b, an electric magnet 70a, and a self-holding solenoid 70b. The board 10 is formed of a resin. The board 10 is provided with a rectangular opening 11.

Trailing blades 20B includes four blades 21b to 24b. Also, reading blades 20A includes four blades. However, only one blade 21a is illustrated in FIGS. 1 and 2. FIGS. 1 to 3 illustrate a case where the reading blades 20A are overlapped with each other and the trailing blades 20B are expanded. In FIGS. 1 to 3, the reading blades 20A recede from the opening 11 and the trailing blades 20B close the opening 11.

As illustrated in FIG. 2, the reading blades 20A are connected with the arms 31a and 32a. The trailing blades 20B are connected with the arms 31b and 32b. Each of the arms 31a, 32a, 31b, and 32b is swingably supported by the board 10. The arms 31a and 31b are respectively provided with fitting holes 33a and 33b.

As illustrated in FIG. 3, the board 10 is provided with a reading blade-driving lever 40a and a trailing blade-driving lever 40b which respectively drive the arms 31a and 31b. The reading blade-driving lever 40a and the trailing blade-driving lever 40b are respectively provided with spindles 45a and 45b. The spindles 45a and 45b are rotatably supported by the board 10. Thus, each of the reading blade-driving lever 40a and the trailing blade-driving lever 40b is swingably supported in a given range by the board 10. The reading blade-driving lever 40a and the trailing blade-driving lever 40b are respectively provided with drive pins 43a and 43b. The board 10 is provided with escape holes 13a and 13b which respectively escape the movements of the drive pins 43a and 43b. Each of the escape holes 13a and 13b has an arc shape. The drive pins 43a and 43b are respectively fitted into the fitting hole 33a of the arm 31a and the fitting hole 33b of the arm 31b. Swinging the reading blade-driving lever 40a causes the arm 31a to swing and to move the reading blades 20A. Likewise, swinging the trailing blade-driving lever 40b causes the arm 31a to swing and to move the trailing blades 20B.

The reading blade-driving lever 40a and the trailing blade-driving lever 40b respectively include movable iron pieces 47a and 47b. The reading blade-driving lever 40a is swingable from a position where the movable iron piece 47a abuts the electric magnet 70a to a position where the movable iron piece 47a is spaced from the electric magnet 70a. The configuration of the trailing blade-driving lever 40b is the same. The spindles 45a and 45b are respectively fitted with the bias springs 60a and 60b each having a coil shape. The bias spring 60a biases the reading blade-driving lever 40a in such a direction that the movable iron piece 47a moves away from the electric magnet 70a. Likewise, the bias spring 60b biases the trailing blade-driving lever 40b in such a direction that the movable iron piece 47b moves away from the self-holding solenoid 70b.

The spindles 45a and 45b respectively engage ratchet gears 50a and 50b. The ratchet gear 50a engages one end of the bias spring 60a. The other end of the bias spring 60a engages the reading blade-driving lever 40a. The rotational degree of the ratchet gear 50a is adjusted, so that the biasing force of the bias spring 60a can be adjusted. The ratchet gear 50b has the same function of the ratchet gear 50a.

The electric magnet 70a is energized to be able to adsorb the movable iron piece 47a. The self-holding solenoid 70b is able to adsorb the movable iron piece 47b in the non-energized state, and the adsorption force effecting the movable iron piece 47b is weakened by the energization, as will be described later in more detail.

A set lever 90 is provided for respectively positioning the reading blade-driving lever 40a and the trailing blade-driving lever 40b at given positions. The set lever 90 includes a spindle portion 95 rotatably supported by the board 10. A return spring 80 for retuning the set lever 90 to the initial position is attached to the set lever 90. The spindle portion 95 is fitted with the return spring 80. One end of the return spring 80 abuts a projection 18 formed on the board 10. The other end of the return spring 80 abuts a projection 98 formed in the set lever 90.

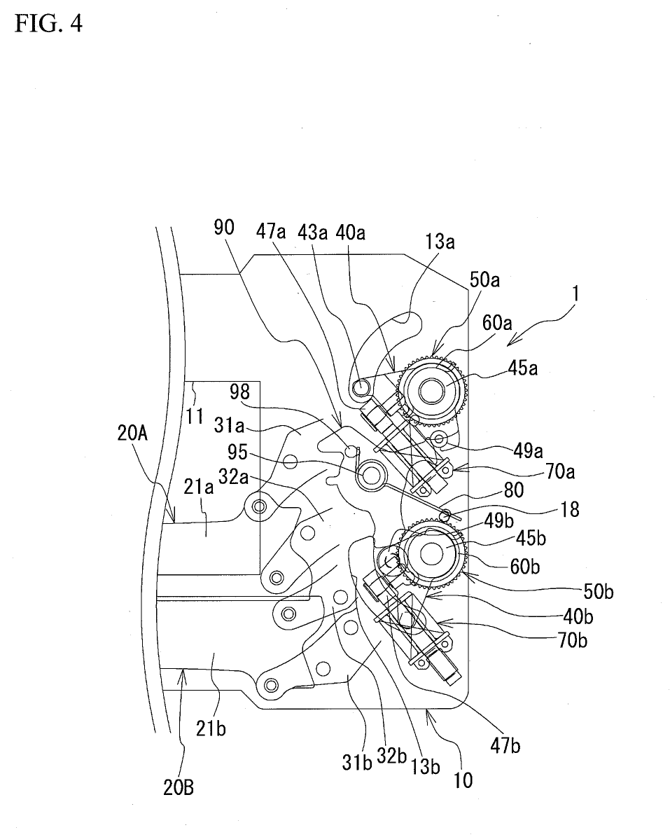

Next, the operation of the focal plane shutter 1 will be described. FIGS. 4 to 8 are explanatory views of the operation of the focal plane shutter 1. Additionally, parts are omitted in FIGS. 4 to 8. FIGS. 1 to 3 illustrate the state immediately after the exposure operation is finished. In the state immediately after the exposure operation is finished, the reading blade-driving lever 40a is rotated clockwise by the biasing force of the bias spring 60a from the state where the movable iron piece 47a abuts the electric magnet 70a, so the movable iron piece 47a moves away from the electric magnet 70a. In this time, the reading blades 20A are overlapped with each other and recede from the opening 11. Additionally, the trailing blade-driving lever 40b are rotated clockwise by the biasing force of the bias spring 60b from the state where the movable iron piece 47b abuts the self-holding solenoid 70b, so the movable iron piece 47b moves away from the self-holding solenoid 70b. Therefore, the trailing blades 20B expand to close the opening 11.

Next, as illustrated in FIG. 4, the set lever 90 is rotated clockwise from the initial state against the biasing force of the return spring 80 by a member, not shown, provided in a camera. Therefore, the set lever 90 abuts rollers 49a and 49b respectively provided in the reading blade-driving lever 40a and the trailing blade-driving lever 40b and rotates the reading blade-driving lever 40a and the trailing blade-driving lever 40b counterclockwise. Therefore, the reading blades 20A expand to close the opening 11 and the trailing blades 20B recede from the opening 11. Additionally, FIG. 4 illustrates only the blade 21a of the reading blades 20A and only the blade 21b of the trailing blades 20B. In this state, the movable iron pieces 47a and 47b respectively abut the electric magnet 70a and the self-holding solenoid 70b.

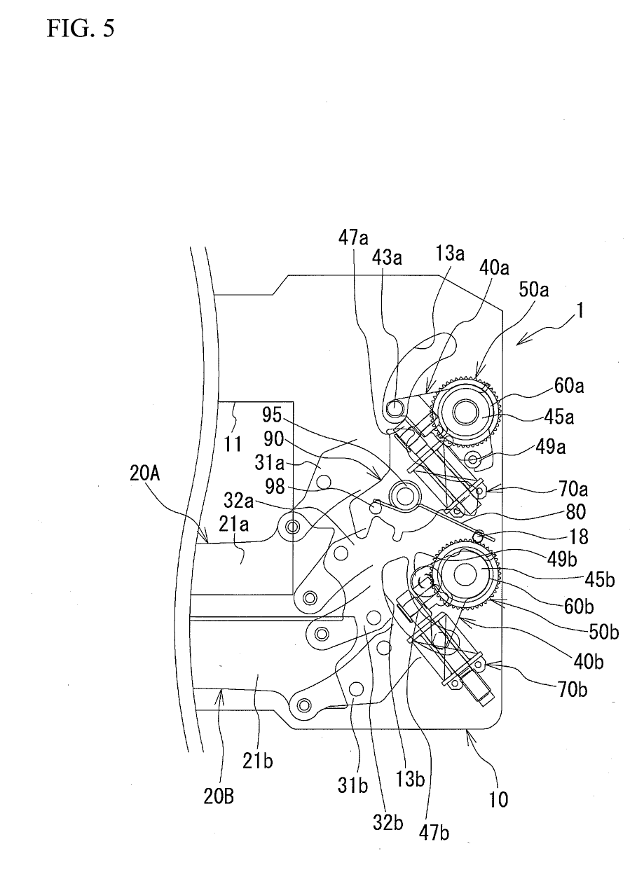

Next, the coil of the electric magnet 70a is energized, so the magnetic adsorptive force is generated between the electric magnet 70a and the movable iron piece 47a. After that, the set lever 90 is rotated clockwise by the biasing force of the return spring 80, and then recede from the reading blade-driving lever 40a and the trailing blade-driving lever 40b as illustrated in FIG. 5. In this case, the self-holding solenoid 70b adsorbs the movable iron piece 47b in the non-energized state. FIG. 5 illustrates the completion of the set operation.

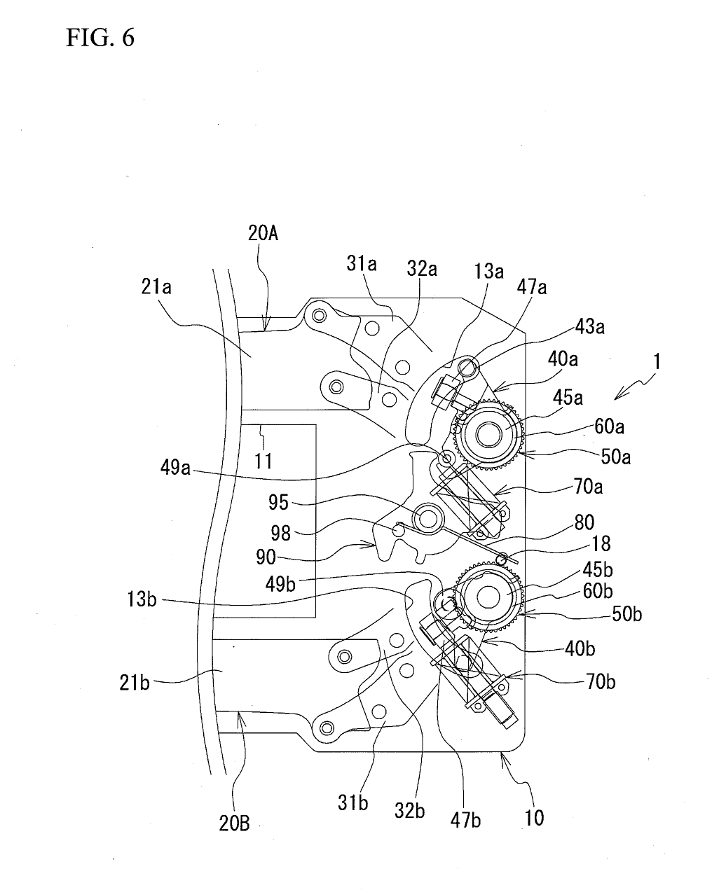

After that, in shooting, a release button of the camera is pushed, so the energization of the coil of the electric magnet 70a is cut off, and the reading blade-driving lever 40a is rotated clockwise by the biasing force. For this reason, the reading blades 20A recede from the opening 11. The trailing blades 20B remain receding from the opening 11. Therefore, the opening 11 is opened. FIG. 6 illustrates the exposure state.

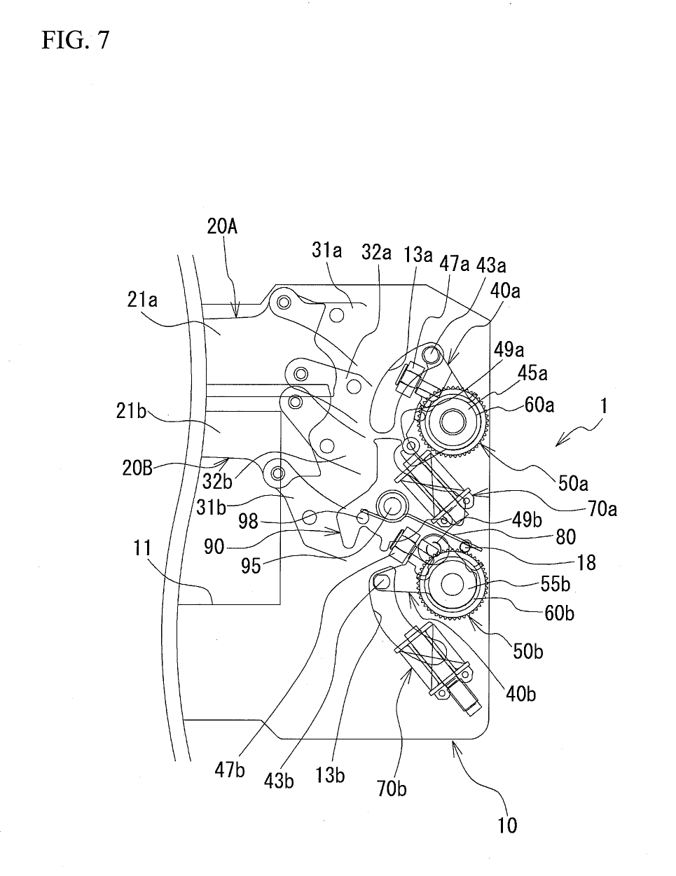

After a given period has passed since the release button is pushed, the coil of the self-holding solenoid 70b is energized, and then the magnetically adsorptive force which effects between the self-holding solenoid 70b and the movable iron piece 47b is weakened. Therefore, the biasing force of the bias spring 60b causes the trailing blade-driving lever 40b to rotate clockwise. Therefore, the trailing blades 20B close the opening 11. FIG. 7 illustrates the state immediately after the exposure operation. FIG. 7 is similar to FIG. 1. In this way, one cycle of the shooting is finished. The energization of the coil of the self-holding solenoid 70b is cut off after a given period has passed since the energization is started. The state where the opening 11 is fully opened as illustrated in FIG. 6 is formed in shooting moving images in addition to in shooting photos.

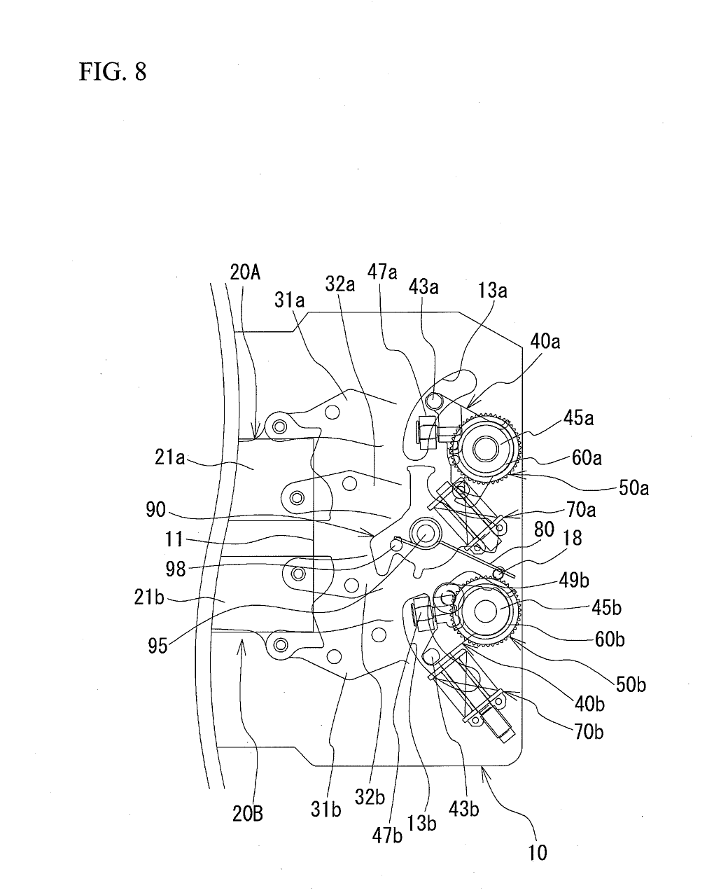

FIG. 8 illustrates the state of the focal plane shutter 1 at the high speed shooting. In the high speed shooting, after the energization of the coil of the electric magnet 70a is cut off in the accomplished state of the set operation as illustrated in FIG. 5, the coil of the self-holding solenoid 70b is energized to drive the trailing blades 20B, before the reading blades 20A fully recede from the opening 11. Therefore, the blades 21a and 21b run over the opening 11 with a clearance between the blades 21a and 21b being smaller than the opening 11.

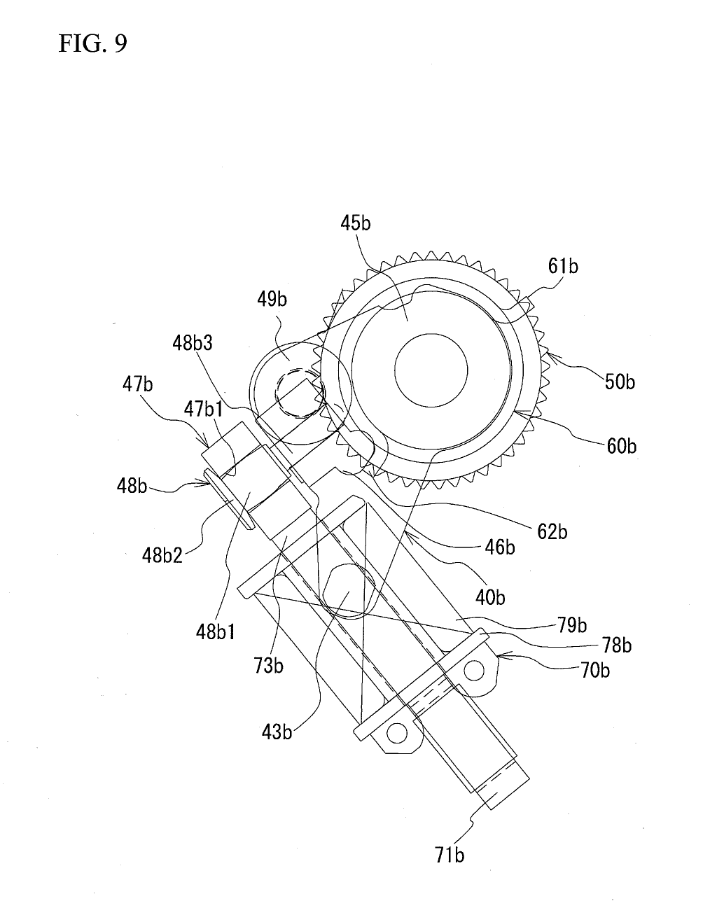

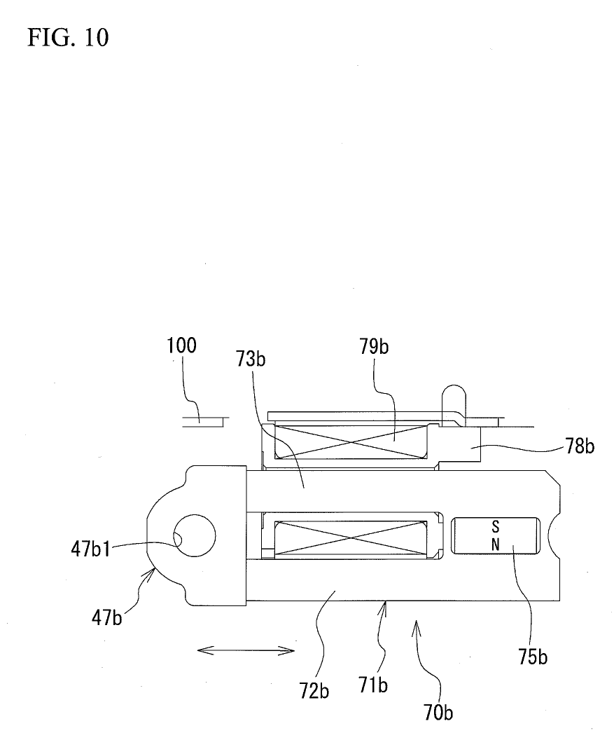

Next, the self-holding solenoid 70b will be described. FIG. 9 is a top view of the self-holding solenoid 70b. FIG. 10 is a side view of the self-holding solenoid 70b. FIGS. 9 and 10 illustrate the self-holding solenoid 70b which abuts the movable iron piece 47b. Additionally, FIG. 9 also illustrates the trailing blade-driving lever 40b.

As illustrated in FIG. 10, the self-holding solenoid 70b includes: a yoke 71b with a lateral U shape when viewed from the side thereof; a coil bobbin 78b attached to the yoke 71b; a coil 79b wound around the coil bobbin 78b; and a permanent magnet 75b secured to the yoke 71b. Additionally, the coil bobbin 78b is secured to a printed board 100 not shown in FIGS. 1 to 9. The coil 79b is connected to the printed board 100. The self-holding solenoid 70b includes arm portions 72b and 73b. The coil bobbin 78b is fitted onto the arm portion 73b. The permanent magnet 75b is secured at a substantial center of a portion where the arm portions 72b and 73b are connected to each other. The permanent magnet 75b is magnetized to have N polarity in the arm portion 72b side and S polarity in the arm portion 73b side. In the non-energized state of the coil 79b, the arm portion 72b is excited to have N polarity and the arm portion 73b is excited to have S polarity by the influence of the permanent magnet 75b. Accordingly, even when the coil 79b is not energized, the yoke 71b acts as a magnet to adsorb and hold the movable iron piece 47b.

The coil 79b is energized such that the polarities generated by the influence of the permanent magnet 75b cancel each other. The coil 79b is energized in this manner, so that the adsorptive force effecting the movable iron piece 47b is weakened. Since the trailing blade-driving lever 40b is biased in such a direction that the movable iron piece 47b is moved away from the self-holding solenoid 70b by the bias spring 60b, the trailing blade-driving lever 40b is rotated by the biasing force of the bias spring 60b, when the adsorptive force is smaller than the biasing force of the bias spring 60b. In this manner, the movable iron piece 47b adsorbed to the self-holding solenoid 70b is moved away therefrom.

As illustrated in FIGS. 9 and 10, the movable iron piece 47b is provided with a through hole 47b1. An engagement portion 48b penetrates through the through hole 47b1. The engagement portion 48b has a pin shape. Additionally, the engagement portion 48b is omitted in FIG. 10. The engagement portion 48b includes: a body portion 48b1; a thin shaft portion 48b3 provided at a rear end of the body portion 48b1; and a flange portion 48b2 provided at a front end of the body portion 48b1. The thin shaft portion 48b3 is thinner than the body portion 48b1. The thin shaft portion 48b3 is fitted into and secured to a hole formed at a holding portion 46b of the trailing blade-driving lever 40b. The body portion 48b1 fits into the through hole 47b1. The flange portion 48b2 prevents the body portion 48b1 from being disengaged from the movable iron piece 47b. In this manner, the movable iron piece 47b engages the engagement portion 48b. The engagement portion 48b is made of a metal and a non-magnetic material. For example, the engagement portion 48b may be made of copper, aluminum, or stainless steel not magnetized. The engagement portion 48b is made of a non-magnetic material so as to prevent the engagement portion 48b from being magnetized.

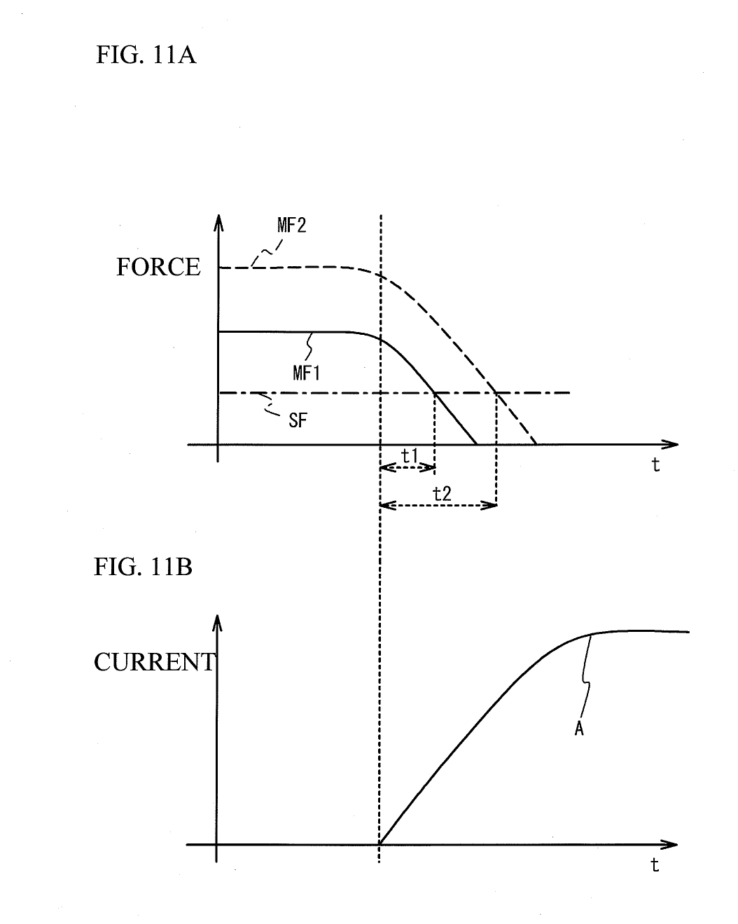

Next, a description will be given of a problem in a case where the above engagement portion may be made of a magnetic material. FIG. 11A is a graph showing a relationships between an adsorption force effecting on a movable iron piece 47b and a biasing force effecting on a trailing blade-driving lever 40b. FIG. 11B is a graph showing the energization state of the self-holding solenoid 70b. In FIG. 11A, a vertical axis indicates force, and a horizontal axis indicates lapse time. In FIG. 11B, a vertical axis indicates current in the coil 79b of the self-holding solenoid 70b, and a horizontal axis indicates lapse time.

FIG. 11A illustrates adsorptive force MF1 effecting on the movable iron piece 47b in a case where the engagement portion is not magnetized and adsorptive force MF2 effecting on the movable iron piece 47b in a case where the engagement portion is magnetized. Also, FIG. 11A illustrates a biasing force SF of the bias spring 60b. Further, the direction of the biasing force SF is opposite to the directions of the adsorptive forces MF1 and MF2.

A description will be given of the case where the engagement portion is not magnetized. When the current A starts flowing through the coil 79b in the state where the movable iron piece 47b is adsorbed to the yoke 71b in the non-energized state, the adsorptive force MF1 is gradually decreased. When the adsorptive force MF1 becomes lower than the biasing force SF, the movable iron piece 47b is moved away from the yoke 71b by the biasing force of the biasing spring 60b. Then, the value of the current A flowing through the coil 79b achieves a value beforehand set. The period t1 is from the time the coil 79b is energized to the time the adsorptive force MF1 is lower than the biasing force SF.

Next, a description will be given of the case where the engagement portion is magnetized. In a case where the engagement portion is made of a magnetic material, when the movable iron piece 47b is adsorbed to the yoke 71b for a long period, the engagement portion is magnetized. When the engagement portion is magnetized, the adsorptive force MF2 effecting on the movable iron piece 47b becomes larger than the adsorptive force MF1 in the case where the engagement portion is not magnetized. In such a state, the current A flows through the coil 79b, so that the adsorptive force MF2 is gradually decreased and the adsorptive force MF2 is smaller than the biasing force SF. The period t2 is from the time the coil 79b is energized to the time the adsorptive force MF2 is lower than the biasing force SF.

As shown in FIG. 11A, the period t2 is longer than the period t1. That is, timings when the movable iron piece 47b is moved away from the yoke 71b are different depending on whether or not the engagement portion is magnetized. For this reason, there are variations in the operation of the trailing blade-driving lever 40b.

For example, when the shutter operation is performed after the engagement portion is magnetized, t2 is the period from the time the coil 79b starts being energized to the time the movable iron piece 47b is moved away from the yoke 71b. In this case, the yoke 71b, the movable iron piece 47b, and the engagement portion are demagnetized by the energization of the coil 79b. Therefore, after the engagement portion is demagnetized and the set operation is performed again so that the movable iron piece 47b is adsorbed to the yoke 71b, the shutter operation is performed before the engagement is magnetized, t1 is the period from the time the coil 79b starts being energized to the time the movable iron piece 47b is moved away from the yoke 71b. In this way, there are variations in operation timings of the trailing blades 20B, and in shutter speeds as the exposure periods.

However, in the focal plane shutter 1 according to the present embodiment, the engagement portion 48b is made of a non-magnetic material so as not to be magnetized. Accordingly, the above mentioned variations in the operations of the trailing blade-driving lever 40b can be suppressed. Consequently, the variations in the shutter operation can be suppressed.

Further, the engagement portion 48b is made of a metal. If the engagement portion 48b is made of a synthetic resin, the engagement portion 48b might be cut away by the movable iron piece 47b and then the cut-away chips might be generated, since the engagement portion 48b engages the movable iron piece 47b made of a metal. Such a problem can be prevented by using the engagement portion 48b made of a metal.

Further, the self-holding solenoid 70b can maintain the trailing blades 20B receding from the opening 11 in the non-energized state. Thus, the exposure state as illustrated in FIG. 6 can be maintained, while the electric magnet 70a and the self-holding solenoid 70b are not energized. Accordingly, power consumption can be suppressed in the focal plane shutter 1. To be specific, in the live view mode of displaying images from an image pickup device on a crystal liquid monitor or the like in real time, or in the moving image-shooting mode that the exposure state is maintained for a long period, power consumption can be suppressed.

While the exemplary embodiments of the present invention have been illustrated in detail, the present invention is not limited to the above-mentioned embodiments, and other embodiments, variations and modifications may be made without departing from the scope of the present invention.

In the above embodiment, the engagement portion holding the movable iron piece is separately provided from the driving lever. However, the present invention is not limited to such a configuration. For example, the engagement portion holding the movable iron piece may be integrally provided with the driving lever.

Further, the engagement portion 48b is made of a metal. However, the engagement portion 48b may be made of a synthetic resin.

An optical device including the focal plane shutter 1 according to the present embodiment is a single-lens reflex camera, a digital camera, or the like.

Finally, several aspects of the present invention are summarized as follows.

According to an aspect of the present invention, there is provided a focal plane shutter including: a board including an opening; a blade closing and opening the opening; a driving lever holding a movable iron piece, swingably supported, and driving the blade; a self-holding solenoid being able to adsorb the movable iron piece in a non-energized state, and an adsorptive force in an energized state being smaller than an adsorptive force in the non-energized state; and a biasing member biasing the driving lever to move away from the self-holding solenoid, wherein the driving lever includes an engagement portion engaging the movable iron piece and made of a non-magnetic material.

The engagement portion is made of a non-magnetic material so as not to be magnetized. This can suppresses the variations in the shutter operation which might be caused in a case where the engagement portion is made of a magnetizable material.

What is claimed is:

1. A focal plane shutter comprising:
a board including an opening;
a blade closing and opening the opening;
a driving lever holding a movable iron piece, swingably supported, and driving the blade;
a self-holding solenoid being able to adsorb the movable iron piece in a non-energized state, and an adsorptive force in an energized state being smaller than an adsorptive force in the non-energized state; and
a biasing member biasing the driving lever to move away from the self-holding solenoid,
wherein the driving lever includes an engagement portion engaging the movable iron piece and made of a non-magnetic material.

2. The focal plane shutter of claim 1, wherein the engagement portion is made of a metal.

3. The focal plane shutter of claim 1, wherein:
the blade includes leading blades and trailing blades each including a plurality of blades;
the driving lever includes a leading blade-driving lever for driving the leading blades and a trailing blade-driving lever for driving the trailing blades; and
the self-holding solenoid is able to adsorb the movable iron piece held in the trailing blade-driving lever in the non-energized state.

4. An optical device comprising
the focal plane shutter comprising:
a board including an opening;
a blade closing and opening the opening;
a driving lever holding a movable iron piece, swingably supported, and driving the blade;
a self-holding solenoid being able to adsorb the movable iron piece in a non-energized state, and an adsorptive force in an energized state being smaller than an adsorptive force in the non-energized state; and
a biasing member biasing the driving lever to move away from the self-holding solenoid,
wherein the driving lever includes an engagement portion engaging the movable iron piece and made of a non-magnetic material.
